(19) United States
(12) Patent Application Publication
(10) Pub. No.: US 2016/0286186 A1
(43) Pub. Date: Sep. 29, 2016

(54) PROJECTION APPARATUS

(71) Applicant: Panasonic Intellectual Property Management Co., Ltd., Osaka (JP)

(72) Inventor: KENJI FUJIUNE, Osaka (JP)

(21) Appl. No.: 15/178,843

(22) Filed: Jun. 10, 2016

Related U.S. Application Data
(63) Continuation of application No. PCT/JP2015/004966, filed on Sep. 30, 2015.

(30) Foreign Application Priority Data
Dec. 25, 2014 (JP) 2014-263634

(51) Int. Cl. H04N 9/31; H04N 9/74

(52) U.S. Cl. CPC H04N 9/3185; H04N 9/3141; H04N 9/74

(57) ABSTRACT

A projection apparatus includes a detector that detects a specific object, a projection unit that projects a projection image indicated by a video signal, a driving unit that changes a direction of the projection unit in order to change a projecting position of the projection image, and a controller that controls the driving unit. The controller controls movement of the driving unit to project the projection image at a position that follows movement of the specific object detected by the detector. The controller also controls processing of an image object included in the projection image in accordance with the movement of the driving unit. This allows the projection apparatus that follows the movement of the specific object and projects video, to implement image projection with highlighting effects.

### BACKGROUND

1. Technical Field

The present disclosure relates to a projection apparatus that detects a predetermined object, follows the detected object, and projects video.

2. Description of the Related Art

In recent years, as a method for providing information on advertisement and guidance to a moving person, a widespread advertisement method uses a display device, such as a liquid crystal display device and a projector (digital signage). Furthermore, a liquid crystal display device under research and development detects a moving person and individually displays information to the detected person (for example, refer to Unexamined Japanese Patent Publication No. 2005-115270 and Unexamined Japanese Patent Publication No. 2012-118121).

Unexamined Japanese Patent Publication No. 2005-115270 discloses a movable-body accompanying information display device including a video camera that captures a movable body passing a background defined within a fixed frame on a wall or on a floor, an image processor that sequentially extracts position coordinates of the movable body entering the current image sequentially captured by the video camera, calculates position coordinates for display away from the respective position coordinates based on the extracted respective position coordinates, and sequentially inserts information such as text and image into the calculated respective position coordinates for display in a prescribed display size to output a result as video information, and a video display device that displays video information such as text and image in a prescribed display size on a display screen as the movable body moves.

Similar to the display device of Unexamined Japanese Patent Publication No. 2005-115270, detecting a moving person and presenting information individually to the detected person is effective in increasing a possibility of conveying information more securely to the person. In order to convey information more effectively, it is considered effective to add various highlighting effects to a method for displaying the information.

### SUMMARY

The present disclosure provides a projection apparatus that can present a projection image that adds highlighting effects to a specific object (for example, a person).

In one aspect of the present disclosure, the projection apparatus includes a detector that detects the specific object, a projection unit that projects a projection image indicated by a video signal, and a controller that controls a driving unit to project the projection image at a position that follows movement of the specific object detected by the detector, the controller controlling processing of an image object included in the projection image in accordance with movement of the driving unit.

The present disclosure may change the content of the projection image in accordance with the movement of the driving unit, and may therefore add various highlighting effects to a method for projecting the video.

### BRIEF DESCRIPTION OF THE DRAWINGS

FIG. 1 is a schematic view illustrating a state in which a projector apparatus projects video on a wall;

FIG. 2 is a schematic view illustrating a state in which the projector apparatus projects video on a floor;

FIG. 3 is a block diagram illustrating an electric configuration of the projector apparatus;

FIG. 4A is a block diagram illustrating an electric configuration of a distance detector;

FIG. 4B is a diagram for describing distance information acquired by the distance detector;

FIG. 5 is a block diagram illustrating an optical configuration of the projector apparatus;

FIG. 6 is a diagram for describing an example of use of the projector apparatus;

FIG. 7A is a diagram for describing movement of a driving unit;

FIG. 7B is a diagram for describing a projection image that rotates in accordance with the movement of the driving unit;

FIG. 8 is a diagram illustrating a projection image that performs blur processing in accordance with the movement of the driving unit;

FIG. 9 is a block diagram illustrating a functional configuration of a controller of the projector apparatus according to a first exemplary embodiment;

FIG. 10 is a block diagram illustrating a functional configuration of the controller of the projector apparatus according to a second exemplary embodiment;

FIG. 11 is a block diagram illustrating a functional configuration of the controller of the projector apparatus according to a third exemplary embodiment; and

FIG. 12 is a diagram for describing images of footprints to be added for highlighting according to the third exemplary embodiment.

### DETAILED DESCRIPTION

Exemplary embodiments will be described in detail below with reference to the drawings as needed. However, a description more detailed than necessary may be omitted. For example, a detailed description of already well-known items and a repeated description regarding substantially identical components may be omitted. This is intended to avoid making the following description unnecessarily redundant and to make it easier for a person skilled in the art to understand the exemplary embodiments.

It is to be noted that the applicant provides the accompanying drawings and the following description in order for a person skilled in the art to fully understand the present disclosure, and that the applicant does not intend to limit the subject described in the appended claims.

### First Exemplary Embodiment

The first exemplary embodiment will be described below with reference to the accompanying drawings. Hereinafter, a projector apparatus will be described as a specific exemplary embodiment of a projection apparatus according to the present disclosure.

### 1-1. Summary

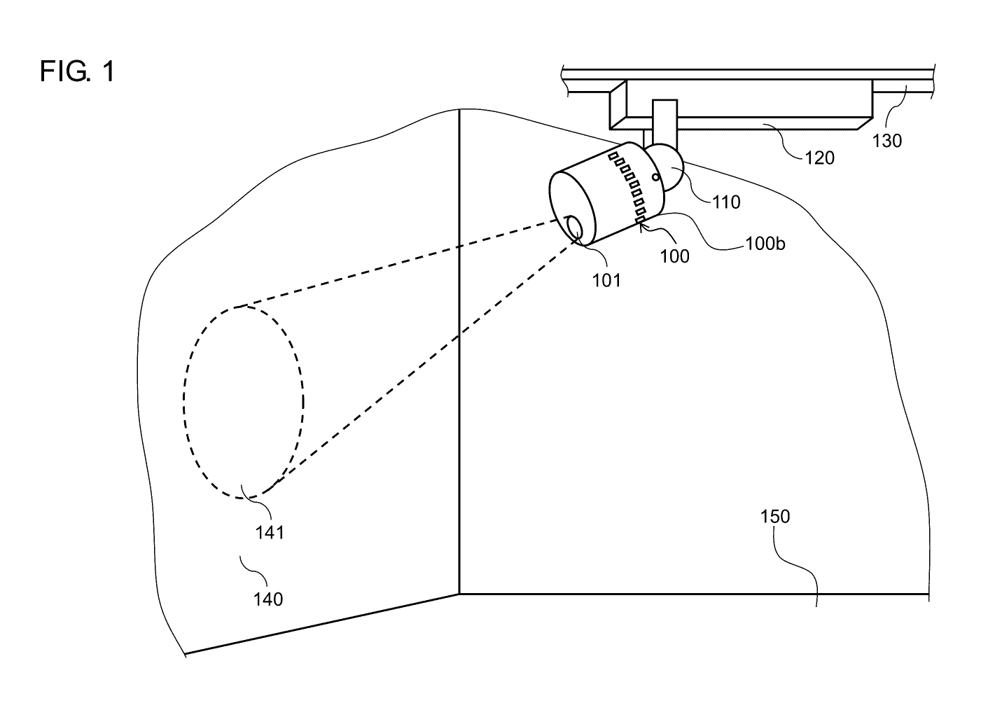

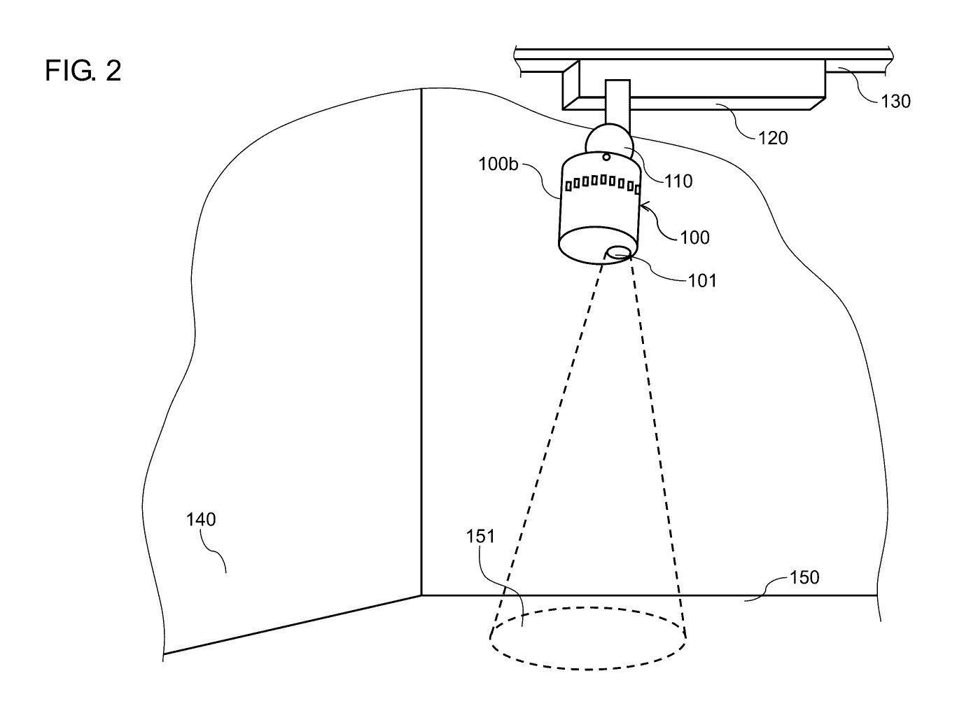

A video projection operation to be performed by projector apparatus 100 will be briefly described with reference to FIG. 1 and FIG. 2. FIG. 1 is an image diagram in which projector apparatus 100 projects video on wall 140. FIG. 2 is an image diagram in which projector apparatus 100 projects video on floor 150.

As illustrated in FIG. 1 and FIG. 2, projector apparatus 100 is fixed to housing 120 together with driving unit 110. Wiring electrically connected to components of projector main body 100b and driving unit 110 is connected to a power supply through housing 120 and wiring duct 130. This supplies projector main body 100b and driving unit 110 with electric power. Projector apparatus 100 has aperture 101 in projector main body 100b. Projector apparatus 100 projects video through aperture 101.

Driving unit 110 can change a projection direction of projector apparatus 100 by driving projector main body 100b and changing a direction of projector main body 100b. As illustrated in FIG. 1, driving unit 110 can drive projector main body 100b so that the projection direction of projector apparatus 100 may be a direction toward wall 140. This allows projector apparatus 100 to project video 141 on wall 140. Similarly, driving unit 110 can drive projector main body 100b so that the projection direction of projector apparatus 100 may be a direction toward floor 150, as illustrated in FIG. 2. This allows projector apparatus 100 to project video 151 on floor 150. Driving unit 110 may drive projector main body 100b in response to a manual operation of a user, or may drive projector main body 100b automatically in accordance with a detection result of a predetermined sensor. In addition, video 141 to be projected on wall 140 and video 151 to be projected on floor 150 may have different content, and may have identical content. Driving unit 110 includes an electric motor, and can change a direction (posture) of projector apparatus 100 and can change a projection direction and projecting position of the video by causing projector main body 100b to swing in a horizontal direction (panning direction) and vertical direction (tilting direction).

Projector apparatus 100 can detect a specific object, follow movement of the detected object, and project video (content) at a position or area that has a predetermined positional relationship with a position of the specific object. In the following description, a “person” is detected as the specific object, and control for following movement of the detected person to project video is referred to as “person following control”.

### 1-2. Configuration

The configuration and operations of projector apparatus 100 will be described in detail below.

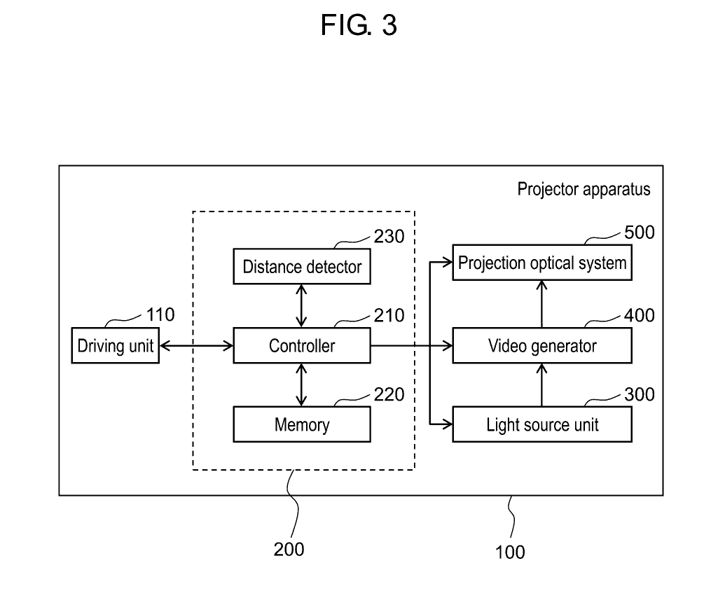

FIG. 3 is a block diagram illustrating an electric configuration of projector apparatus 100. Projector apparatus 100 includes drive controller 200, light source unit 300, video generator 400, and projection optical system 500. The configuration of each unit that constitutes projector apparatus 100 will be sequentially described below.

Drive controller 200 includes controller 210, memory 220, and distance detector 230.

Controller 210 is a semiconductor element that controls projector apparatus 100 as a whole. That is, controller 210 controls operations of each unit that constitutes drive controller 200, such as distance detector 230 and memory 220, and operations of light source unit 300, video generator 400, and projection optical system 500. Also, controller 210 can perform digital zoom control for scaling a projection image by video signal processing, and geometric correction on the projection video in consideration of a direction of a projection surface. In addition, controller 210 controls driving unit 110 to change a projection direction and projecting position of projected light from projector apparatus 100. Controller 210 acquires, from driving unit 110, information regarding a current control position in a panning direction and tilting direction of driving unit 110, and information regarding a speed at the time when driving unit 110 changes a direction of projector main body 100b in the panning direction and tilting direction. Controller 210 may be configured using only hardware, or may be implemented by combining hardware and software. For example, controller 210 may be configured using one or more CPUs, MPUs, and the like.

Memory 220 is a storage element for storing various kinds of information. Memory 220 is configured using a flash memory, ferroelectric memory, and the like. Memory 220 stores information such as a control program for controlling projector apparatus 100. In addition, memory 220 stores various kinds of information supplied from controller 210. Furthermore, memory 220 stores information including image data, such as a still picture and moving picture to be projected, a reference table including settings such as a position and projection size for projecting video, and data of a shape of an object as a target for detection.

Distance detector 230 includes, for example, a distance image sensor of a time-of-flight (TOF) system (hereinafter referred to as a TOF sensor), and linearly detects distances to an opposing projection surface and to an object. When distance detector 230 faces wall 140, distance detector 230 detects the distance from distance detector 230 to wall 140. When a picture hangs on wall 140, distance detector 230 can detect the distance to a surface of the picture. Similarly, when distance detector 230 faces floor 150, distance detector 230 can detect the distance from distance detector 230 to floor 150. When an object is mounted on floor 150, distance detector 230 can detect the distance to a surface of the object.

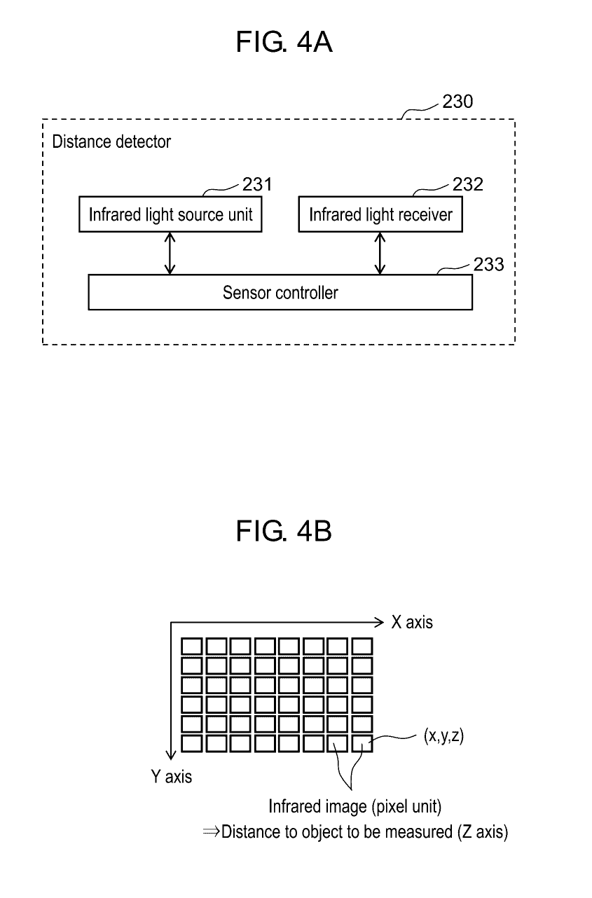

FIG. 4A is a block diagram illustrating an electric configuration of distance detector 230. As illustrated in FIG. 4A, distance detector 230 includes infrared light source unit 231 for emitting infrared detecting light, infrared light receiver 232 for receiving the infrared detecting light reflected by the opposing surface (or the object), and sensor controller 233. Infrared light source unit 231 emits the infrared detecting light to be diffused to all over the surroundings through aperture 101. Infrared light source unit 231 uses, for example, infrared light having wavelengths in a range from 850 nm to 950 nm as the infrared detecting light. Controller 210 stores, in an internal memory, a phase of the infrared detecting light emitted from infrared light source unit 231. When the opposing surface is not equally distant from distance detector 230 and has an inclination or shape, multiple pixels arranged on an imaging surface of infrared light receiver 232 each receive reflected light with separate timing. Since the reflected light is received with separate timing, the infrared detecting light received by infrared light receiver 232 differs in phase at each of the pixels. Sensor controller 233 stores, in the memory, the phase of the infrared detecting light received by infrared light receiver 232 at each pixel.

Sensor controller 233 reads, from the memory, the phase of the infrared detecting light emitted by infrared light source unit 231, and the phase of the infrared detecting light received by infrared light receiver 232 at each pixel. Based on a phase difference between the infrared detecting light emitted by distance detector 230 and the received infrared detecting light, sensor controller 233 can measure the distance from distance detector 230 to the opposing surface, and generate distance information (distance image).

FIG. 4B is a diagram for describing the distance information generated by infrared light receiver 232 of distance detector 230. Distance detector 230 detects the distance from the object that reflects the infrared detecting light based on the aforementioned phase difference at every pixel that constitutes an infrared image made by the received infrared detecting light. This allows sensor controller 233 to obtain a detection result of the distance over the whole range of angle of view of the infrared image received by distance detector 230 on a pixel-by-pixel basis. Controller 210 can acquire the distance information from distance detector 230.

Based on the distance information, controller 210 can detect a projection surface such as wall 140 or floor 150, and a specific object, such as a person or an object.

Although the TOF sensor has been illustrated as distance detector 230 in the above description, the present disclosure is not limited to this example. That is, a device for emitting light of a known pattern, such as a random dot pattern, and for calculating the distance from displacement of the pattern, or a device using parallax caused by a stereoscopic camera may be used. In addition to distance detector 230, projector apparatus 100 may include an RGB camera, which is not illustrated. In this case, projector apparatus 100 may detect the object by using image information that is output from the RGB camera, together with the distance information that is output from the TOF sensor. By also using the RGB camera, projector apparatus 100 can detect the object by using, in addition to information on a three-dimensional shape of the object obtained from the distance information, information including coloration of the object and characters described on the object.

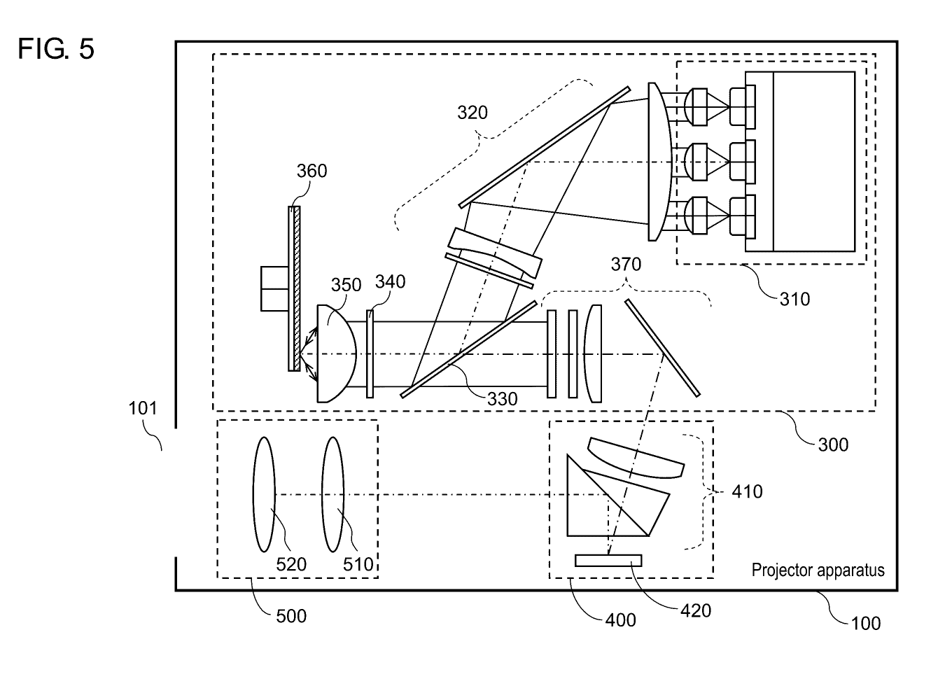

Subsequently, an optical configuration of projector apparatus 100 will be described. That is, the configurations of light source unit 300, video generator 400, and projection optical system 500 of projector apparatus 100 will be described. FIG. 5 is a block diagram illustrating the optical configuration of projector apparatus 100. As illustrated in FIG. 5, light source unit 300 supplies, to video generator 400, light necessary for generating projection video. Video generator 400 supplies the generated video to projection optical system 500. Projection optical system 500 applies optical conversion, such as focusing and zooming, to the video supplied from video generator 400. Projection optical system 500 faces aperture 101 and projects the video through aperture 101.

The configuration of light source unit 300 will be described. As illustrated in FIG. 5, light source unit 300 includes semiconductor laser 310, dichroic mirror 330, quarter-wave plate 340, and phosphor wheel 360.

Semiconductor laser 310 is a solid light source that emits, for example, s-polarized blue light having wavelengths in a range from 440 nm to 455 nm. The s-polarized blue light emitted from semiconductor laser 310 enters dichroic mirror 330 through light-guiding optical system 320.

Dichroic mirror 330 is an optical element that has, for example, a high reflectance of 98% or more with respect to the s-polarized blue light having wavelengths in a range from 440 nm to 455 nm. This optical element also has high transmittance of 95% or more with respect to p-polarized blue light having wavelengths in a range from 440 nm to 455 nm, and with respect to green light to red light having wavelengths in a range from 490 nm to 700 nm regardless of the state of polarization. Dichroic mirror 330 reflects the s-polarized blue light emitted from semiconductor laser 310 in a direction of quarter-wave plate 340.

Quarter-wave plate 340 is a polarizing element that converts linear polarization into circular polarization, or converts circular polarization into linear polarization. Quarter-wave plate 340 is disposed between dichroic mirror 330 and phosphor wheel 360. The s-polarized blue light that enters quarter-wave plate 340 is converted into circularly polarized blue light, and is then emitted on phosphor wheel 360 through lens 350.

Phosphor wheel 360 is an aluminum flat plate configured to allow high-speed revolution. On a surface of phosphor wheel 360, there are formed a plurality of areas including a B area, which is an area of a diffuse reflecting surface, a G area on which green light-emitting phosphor is applied, and an R area on which red light-emitting phosphor is applied. The circularly polarized blue light emitted on the B area of phosphor wheel 360 undergoes diffuse reflection and then enters quarter-wave plate 340 again as circularly polarized blue light. The circularly polarized blue light incident on quarter-wave plate 340 is converted into p-polarized blue light, and then enters dichroic mirror 330 again. At this time, the blue light incident on dichroic mirror 330, which is p-polarized light, passes through dichroic mirror 330 and enters video generator 400 through light-guiding optical system 370.

The blue light or red light emitted on the G area or R area of phosphor wheel 360 excites phosphor applied on the G area or R area to cause emission of green light or red light. The green light or red light emitted from the G area or R area enters dichroic mirror 330. At this time, the green light or red light incident on dichroic mirror 330 passes through dichroic mirror 330, and enters video generator 400 through light-guiding optical system 370.

Since phosphor wheel 360 rotates at a high speed, the blue light, green light, and red light are emitted from light source unit 300 to video generator 400 in a time-sharing manner.

Video generator 400 generates projection video according to a video signal supplied from controller 210. Video generator 400 includes digital-mirror-device (DMD) 420 and the like. DMD 420 is a display element having a large number of micro mirrors arranged on a plane. DMD 420 deflects each of the arranged micro mirrors in accordance with the video signal supplied from controller 210 to spatially modulate incident light. Light source unit 300 emits blue light, green light, and red light in a time-sharing manner. DMD 420 repeatedly receives the blue light, green light, and red light emitted through light-guiding optical system 410 sequentially in a time-sharing manner. DMD 420 deflects each of the micro mirrors in synchronization with timing with which the light of each color is emitted. This causes video generator 400 to generate the projection video in accordance with the video signal. In accordance with the video signal, DMD 420 deflects the micro mirrors to light that travels to projection optical system 500 and light that travels out of an effective range of projection optical system 500. This allows video generator 400 to supply projection optical system 500 with the generated projection video.

Projection optical system 500 includes optical members, such as zoom lens 510 and focus lens 520. Projection optical system 500 enlarges light incident from video generator 400 and projects the light on the projection surface. Controller 210 can control a projection area on a projection target so as to obtain a desired zoom value by adjusting a position of zoom lens 510. To increase the zoom value, controller 210 moves the position of zoom lens 510 in a direction in which an angle of view decreases to narrow the projection area. To decrease the zoom value, on the other hand, controller 210 moves the position of zoom lens 510 in the direction in which the angle of view increases to widen the projection area. In addition, controller 210 can adjust the focus of the projection video by adjusting a position of focus lens 520 based on predetermined zoom tracking data so as to follow movement of zoom lens 510.

Although the above-described configuration uses a digital-light-processing (DLP) system using DMD 420 as an example of projector apparatus 100, the present disclosure is not limited to this example. That is, a configuration under a liquid crystal system may be adopted as projector apparatus 100.

Although the above-described configuration uses a single plate system under which the light source using phosphor wheel 360 is time-shared as an example of projector apparatus 100, the present disclosure is not limited to this example. That is, projector apparatus 100 may adopt a configuration under a three-plate system including various light sources of blue light, green light, and red light.

Although the above-described configuration has separate units including the blue light source for generating the projection video and the infrared light source for measuring distances, the present disclosure is not limited to this example. That is, the blue light source for generating the projection video and the infrared light source for measuring distances may be integrated into one unit. When the three-plate system is adopted, the light sources of respective colors and the infrared light source may be integrated into one unit.

### 1-3. Operations

The operation of projector apparatus 100 having the aforementioned configuration will be described below. Projector apparatus 100 according to the present exemplary embodiment can detect a person as a specific object, follow movement of the detected person, and project predetermined video at a position that has a predetermined positional relationship with a position of the person (for example, at a position 1 m ahead of the position of the detected person in a traveling direction).

Specifically, distance detector 230 radiates a certain area (for example, an entrance of a store or building) with the infrared detecting light to acquire the distance information in the area. Based on the distance information acquired by distance detector 230, controller 210 detects a person and information on the person such as a position, traveling direction, and speed. Here, controller 210 detects the traveling direction and speed from the distance information of multiple frames. Based on the detected information on the person such as the position and traveling direction, controller 210 determines a position at which a projection image is projected. Controller 210 controls driving unit 110 to project the projection image at the determined position, and moves projector main body 100b in a panning direction or tilting direction. Controller 210 detects the position of the person at predetermined time intervals (for example, 1/60 seconds), and based on the detected position of the person, controller 210 projects the projection image so as to cause the projection image to follow the person.

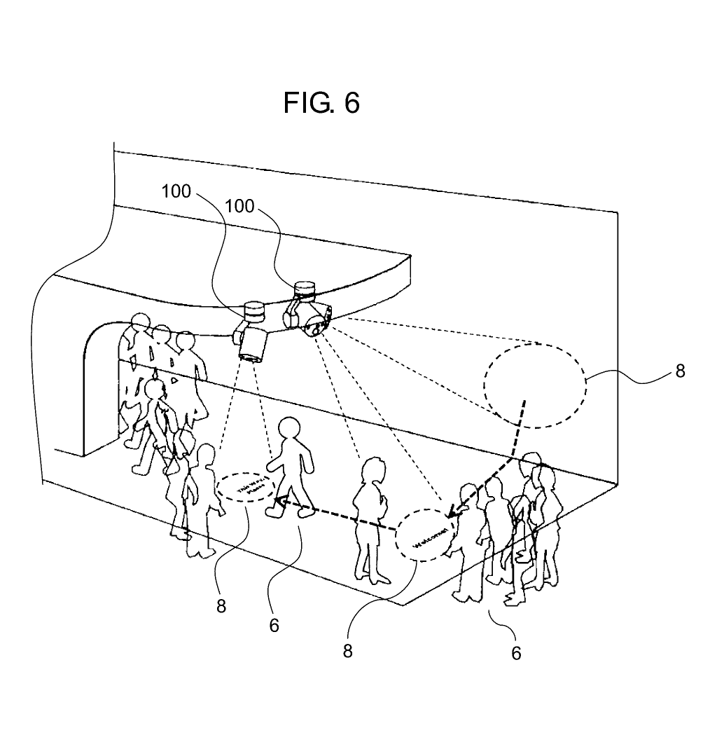

For example, as illustrated in FIG. 6, projector apparatus 100 is installed on a place, such as on a ceiling and wall of a passage and hall within a building, and when person 6 is detected, projector apparatus 100 follows movement of person 6 and project projection image 8. Projection image (content image) 8 includes a figure and image for highlighting movement of person 6, for example, a figure or message, such as an arrow, for leading and guiding person 6 to a predetermined place or store, a message welcoming person 6, advertisement text, and a red carpet. Projection image 8 may be a still picture or may be a moving picture. This allows projector apparatus 100 to present desired information to detected person 6 at an always easy-to-see position in accordance with movement of detected person 6, and the desired information can be conveyed to person 6 without fail.

Furthermore, projector apparatus 100 according to the present exemplary embodiment has a function to change content of the image to be projected in accordance with movement of driving unit 110 made by the person following control. That is, when driving unit 110 is driven so that the image may be projected following the detected person in accordance with the person following control, projector apparatus 100 calculates movement of the projection image from the movement of driving unit 110, and in accordance with the movement, projector apparatus 100 generates the image or performs effect processing on the image. For example, when driving unit 110 moves rapidly in accordance with the person following control, projector apparatus 100 projects a rapidly changing image. On the other hand, when driving unit 110 moves slowly, projector apparatus 100 projects a slowly changing image. Also, when driving unit 110 is turning round and round, projector apparatus 100 may also change the image object within the image to turn round and round. Also, projector apparatus 100 may apply blur processing that adds an afterimage (shading off) to the image in a direction and intensity according to a movement speed of driving unit 110.

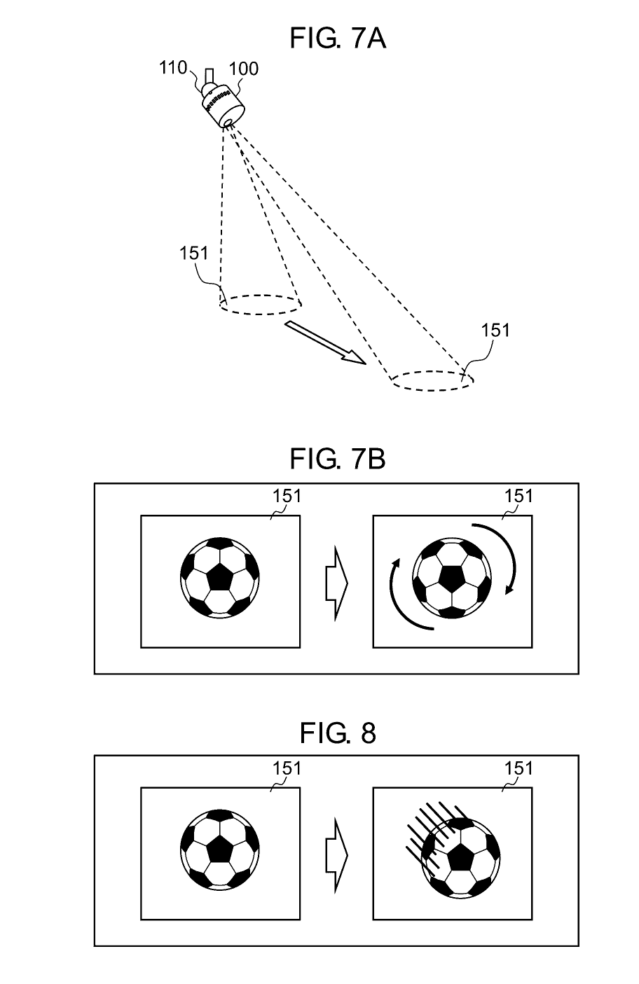

For example, in a case where the projection image indicates a soccer ball, when the person following control results in that driving unit 110 of projector apparatus 100 moves projected video 151 as illustrated in FIG. 7A, projector apparatus 100 projects a rotating soccer ball in accordance with a movement speed of the projection image, that is, in accordance with the movement speed of driving unit 110, as illustrated in FIG. 7B. At this time, projector apparatus 100 changes a rotational speed of the soccer ball in accordance with the movement speed of the projection image, that is, with the movement speed of driving unit 110. Alternatively, as illustrated in FIG. 8, projector apparatus 100 projects a soccer ball image by applying, to the soccer ball image, blur processing that adds an afterimage in the direction and intensity according to the movement of the projection image, that is, according to the movement of driving unit 110.

As described above, according to the movement of driving unit 110 that follows the movement of the person, projector apparatus 100 changes motion parameters, such as a speed, acceleration, and angular speed, of the image object within the image indicated by the video signal. This allows projector apparatus 100 to project the projection image in synchronization between a change in the projecting position and content of the image, and highlighting effects are expected. The operation of projector apparatus 100 will be described in detail below.

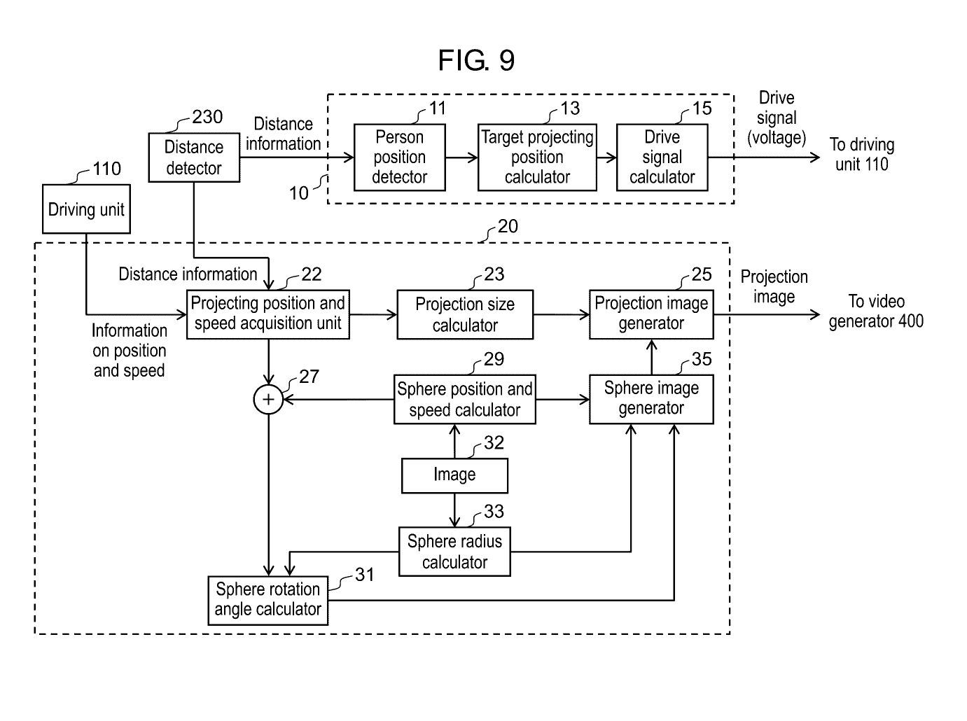

FIG. 9 is a diagram illustrating the functional configuration of controller 210. Controller 210 includes control block 10 that performs the person following control, and control block 20 that adds a video effect for highlighting. A drive signal (voltage) generated by control block 10 is output to driving unit 110 to control drive of driving unit 110. Data of the projection image generated by control block 20 is output to video generator 400, and the projection image is projected through projection optical system 500.

### 1-3-1. Person Following Control

First, the operation of control block 10 that generates the drive signal for the person following control will be described. Here, in the following description, a position and a speed are a two-dimensional vector with magnitude and direction.

Person position detector 11 detects a person by using the distance information from distance detector 230. Person position detector 11 detects a person by previously storing feature amount indicating the person in memory 220 and by detecting a specific object that indicates the feature amount from the distance information. Furthermore, person position detector 11 calculates a position of the detected person (relative position). The “relative position” mentioned herein refers to a position in a coordinate system around a position of driving unit 110. Target projecting position calculator 13 calculates a target projecting position (relative position) of the projection image based on the position of the detected person. For example, a position spaced by a predetermined distance (for example, 1 m) from the position of the detected person in a traveling direction is calculated as the target projecting position. Drive signal calculator 15 calculates a drive signal (voltage) for driving unit 110 that controls the direction of projector apparatus 100 so that the projection image from projector apparatus 100 is projected at the target projecting position (relative position).

### 1-3-2. Image Control for Highlighting

Next, there is described the operation of control block 20 that performs image control for adding the video effect for highlighting. As an example, a sphere (for example, a soccer ball) is assumed as the projection image, and there is described control for changing the rotational speed of the sphere in accordance with movement of driving unit 110 that follows movement of the person.

Projecting position and speed acquisition unit 22 acquire the distance information from distance detector 230. In addition, projecting position and speed acquisition unit 22 acquires, from driving unit 110, information regarding the position (position in the panning direction and the tilting direction) and drive speed of driving unit 110. Based on the information acquired from distance detector 230 and driving unit 110, projecting position and speed acquisition unit 22 calculate the projecting position and movement speed of the currently projected projection image.

Projection size calculator 23 acquires the position of the projection image from projecting position and speed acquisition unit 22, and based on the acquired position of the projection image, projection size calculator 23 calculates a size of the image object included in the image indicated by the video signal. In general, as the image indicated by the identical video signal is projected at a farther position, the size of the projected image increases. Therefore, in order to make the size of the projected image constant regardless of the projected position, the size of the image indicated by the video signal is set to a smaller value as a projection distance of the image increases. Based on the position of the projection image, projection size calculator 23 determines the size of the content image so as to make the size of the projected image constant.

From content image 32 indicated by the video signal, sphere position and speed calculator 29 calculate the position of a virtual sphere, such as a soccer ball within content image 32, and the speed of the virtual sphere within content image 32. Adder 27 adds the speed of the virtual sphere calculated by sphere position and speed calculator 29 to the movement speed of the projection image acquired from projecting position and speed acquisition unit 22. From content image 32 indicated by the video signal, sphere radius calculator 33 calculates a radius of the virtual sphere within content image 32.

Sphere rotation angle calculator 31 calculates a rotation angle of the virtual sphere from the speed added by adder 27 and the radius of the virtual sphere calculated by sphere radius calculator 33. Sphere rotation angle calculator 31 calculates the rotation angle so that the rotation angle increases as the speed of the virtual sphere increases.

Based on the position of the virtual sphere, the radius of the virtual sphere, and the rotation angle of the virtual sphere calculated as described above, sphere image generator 35 generates the image of the virtual sphere that rotates only by the calculated rotation angle.

Projection image generator 25 sets the size of the virtual sphere image generated by sphere image generator 35 to the size calculated by projection size calculator 23, generates the projection image, and outputs the generated projection image to video generator 400.

Since the rotation angle of the projection image generated in this way is determined in accordance with the speed of driving unit 110, as driving unit 110 moves more rapidly, the sphere image that rotates more rapidly will be projected.

Here, an image object whose movement is to be changed in accordance with the movement speed of driving unit 110 is not limited to a sphere. For example, video of a creature, such as a bird, fish, or person, may be projected as the projection image. In this case, projector apparatus 100 may change the movement speed, such as flapping of a bird wing, movement of a caudal fin of a fish, and movement of a hand and leg of a walking person, in accordance with the movement speed of driving unit 110. In addition, a moving object other than a person or animal, such as an automobile and bicycle, may be projected. In this case, a rotational speed of a tire or wheel may be changed in accordance with the movement speed of driving unit 110. In addition, a robot may be projected, and in this case, the movement speed of a hand and leg of the robot may be changed in accordance with the movement speed of driving unit 110.

Although the rotational speed of the image object (sphere) within the projection image is changed in accordance with the movement speed of driving unit 110 in the aforementioned example, the image object within the projection image may be moved linearly. For example, as the image object whose movement is to be changed in accordance with the movement speed of driving unit 110, a texture image (or a background image) of a floor or wall may be projected. In this case, the texture image may be projected while being scrolled forwardly or backwardly in the traveling direction. This may provide a feeling of deceleration or a feeling of acceleration.

### 1-4. Advantageous Effects

As described above, projector apparatus 100 according to the present exemplary embodiment includes: person position detector 11 that detects a person (an example of a specific object); a projection unit that projects a projection image indicated by a video signal (video generator 400 and projection optical system 500); driving unit 110 that changes a direction of the projection unit in order to change a projecting position of the projection image; and controller 210 that controls movement of driving unit 110 to project the projection image at a position that follows movement of the person detected by person position detector 11, controller 210 controlling content of the projection image (for example, a rotational speed of a sphere) in accordance with movement of driving unit 110.

The aforementioned configuration allows projector apparatus 100 to add highlighting effects to the projection image in accordance with the movement of driving unit 110 that follows a person, to present video impressive for a viewing person, and to perform effective leading, guidance, and advertisement about a desired place, store, and the like.

### Second Exemplary Embodiment

The first exemplary embodiment has described the configuration and operation for adding highlighting effects made by rotational movement according to movement of driving unit 110. The present exemplary embodiment describes the configuration and operation for adding highlighting effects made by blur processing that adds an afterimage (shading off) in accordance with movement of driving unit 110. For example, as illustrated in FIG. 8, blur processing according to a movement speed of driving unit 110 is applied to a projection image.

Although the configuration of a projector apparatus according to the present exemplary embodiment is basically similar to the configuration according to the first exemplary embodiment described with reference to FIG. 1 to FIG. 5, a function and operation of controller 210 differ from the function and operation according to the first exemplary embodiment.

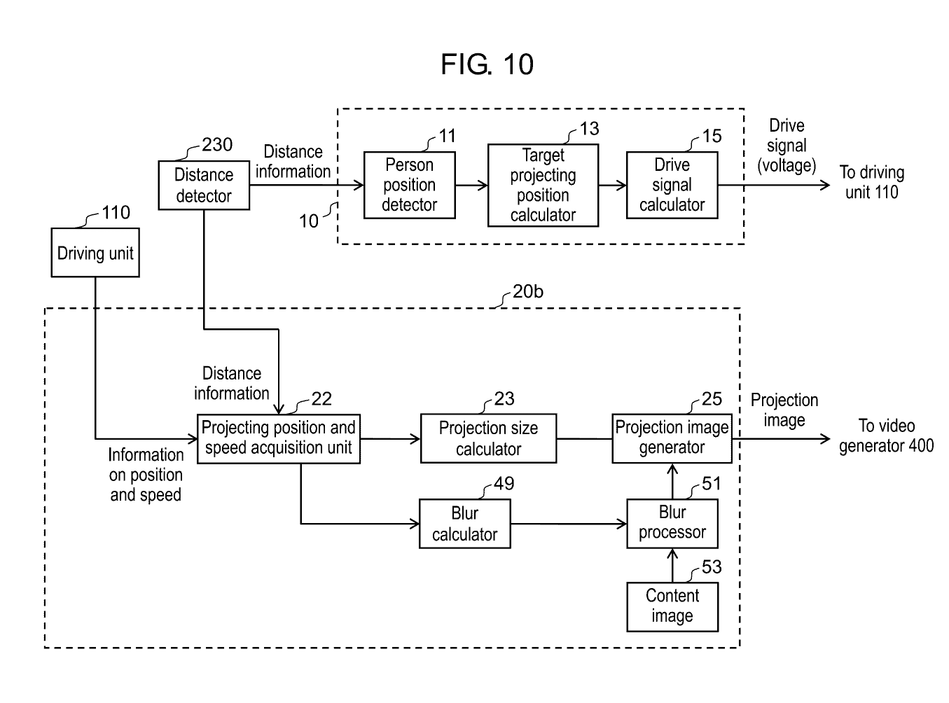

The specific operation of controller 210 according to the present exemplary embodiment will be described with reference to FIG. 10. FIG. 10 is a diagram illustrating the functional configuration of controller 210 according to the present exemplary embodiment. The operation of control block 10 that performs person following control is similar to the operation of the first exemplary embodiment, and thus description thereof will be omitted herein. The operation of control block 20b that performs image control will be described below.

Based on information acquired from each of distance detector 230 and driving unit 110, projecting position and speed acquisition unit 22 calculate a projecting position and movement speed of a currently projected projection image.

Projection size calculator 23 acquires the position of the projection image from projecting position and speed acquisition unit 22, and based on the acquired position of the projection image, projection size calculator 23 calculates a size of a content image indicated by a video signal. Specifically, based on the position of the projection image, projection size calculator 23 determines the size of the content image so as to make the size of the projected image constant at the projected position.

Blur calculator 49 acquires the speed of the projection image from projecting position and speed acquisition unit 22, and based on the acquired speed of the projection image, blur calculator 49 calculates a direction of blur and an amount of blur to be added to the projection image. The amount of blur is set to increase as the speed increases. The direction of blur is set in a direction opposite to a movement direction of the projection image.

Based on the direction of blur and the amount of blur calculated by blur calculator 49, blur processor 51 applies image processing as blur processing to content image 53.

Projection image generator 25 sets the size of the content image subjected to blur processing to the size calculated by projection size calculator 23, generates the projection image, and outputs the generated projection image to video generator 400.

The afterimage according to the movement of driving unit 110 (speed, direction) is added to the projection image generated by projection image generator 25. Therefore, as driving unit 110 moves rapidly, the image may be shown as if the image is moving more rapidly as illustrated in FIG. 8.

### Third Exemplary Embodiment

The present exemplary embodiment describes the configuration and operation of a projector apparatus that projects an image of a footprint according to movement of driving unit 110.

The projector apparatus according to the present exemplary embodiment follows movement of a detected person and projects an image of a footprint. Although the configuration of the projector apparatus is basically similar to those in the first exemplary embodiment and the second exemplary embodiment described with reference to FIG. 1 to FIG. 5, the function of controller 210 differs from those in the first exemplary embodiment and the second exemplary embodiment.

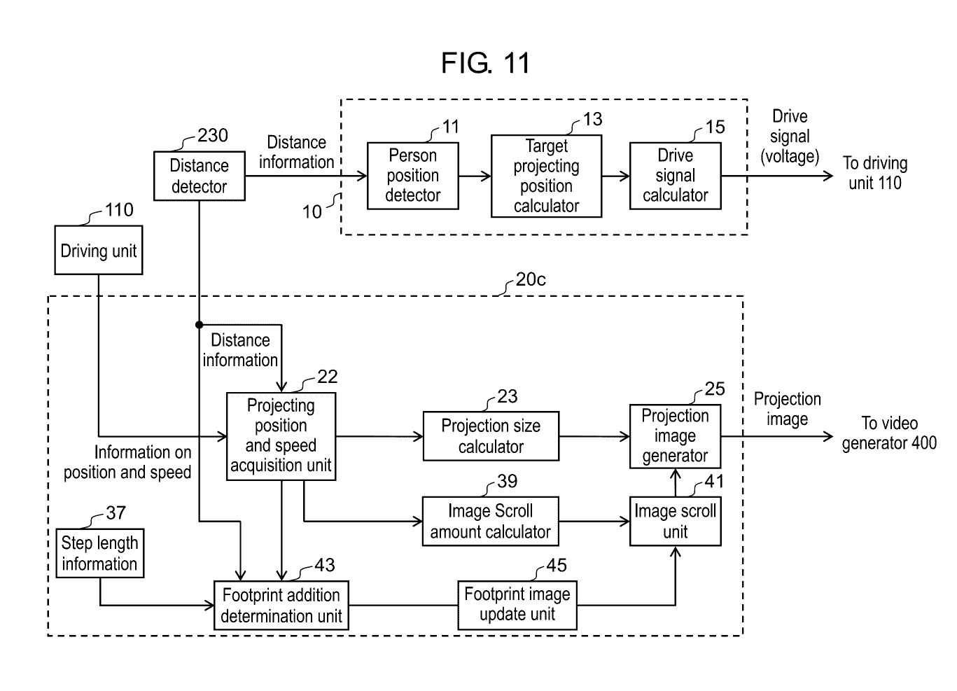

FIG. 11 is a diagram illustrating the functional configuration of controller 210. The operation of control block 10 that performs person following control is similar to those in the first exemplary embodiment and the second exemplary embodiment. The operation of control block 20c that performs image control will be described below.

Based on information acquired from each of distance detector 230 and driving unit 110, projecting position and speed acquisition unit 22 calculate a projecting position and movement speed of a currently projected projection image.

Projection size calculator 23 acquires the position of the projection image from projecting position and speed acquisition unit 22, and based on the acquired position of the projection image, projection size calculator 23 calculates a size of a content image indicated by a video signal.

Image scroll amount calculator 39 calculates a scroll direction and scroll amount for changing (scrolling) a position of the image of a footprint within the image so that the projected image of a footprint seems to stand still, that is, so that the image of a footprint may be projected at an identical position. Specifically, based on the current speed of the projection image (speed, direction) that is input from projecting position and speed acquisition unit 22, image scroll amount calculator 39 calculates the scroll amount and scroll direction for scrolling so as to cancel movement of the projection image.

Step length information 37 stores information regarding a step length value of one step. Footprint addition determination unit 43 determines whether to add a new image of an individual footprint to an image that displays a footprint (hereinafter referred to as a “footprint image”). Footprint addition determination unit 43 calculates a movement distance of a person based on the current position of the projection image from projecting position and speed acquisition unit 22, and distance information from distance detector 230. Footprint addition determination unit 43 then determines whether to add the new individual image of a footprint based on the movement distance of the person. That is, with reference to step length information 37, footprint addition determination unit 43 determines whether the movement distance is equal to or greater than the step length of one step. When the movement distance is equal to or greater than the step length of one step, footprint addition determination unit 43 determines to add the image of a footprint to the current footprint image.

With reference to the determination result from footprint addition determination unit 43, when it is determined that the image of a footprint is to be added, footprint image update unit 45 adds one new image of a footprint to the current footprint image. When it is determined that the image of a footprint is not to be added, the footprint image is not updated.

Image scroll unit 41 performs scroll processing on the footprint image generated by footprint image update unit 45 in accordance with the scroll direction and scroll amount from image scroll amount calculator 39.

Projection image generator 25 sets the size of the image in which the image of a footprint section is scrolled by image scroll unit 41 to the size calculated by projection size calculator 23, generates the projection image, and outputs the generated projection image to video generator 400. Accordingly, the image of a footprint is projected in the vicinity of the detected person.

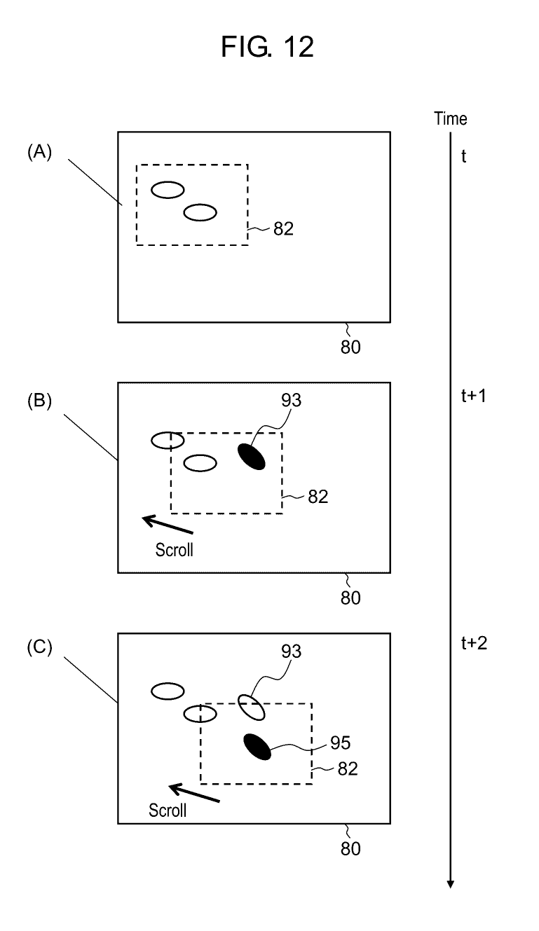

Generation of the footprint image will be described with reference to FIG. 12. Controller 210 assumes virtual image 80 that covers a wide area as illustrated in FIG. 12. Controller 210 then projects only image 82 of a part of the area of virtual image 80 at a position calculated by the person following control. Image 82 includes the image of a footprint. When footprint addition determination unit 43 determines that addition of the footprint is necessary, the footprint is added. Specifically, when the movement of the person equal to or greater than a predetermined step length is detected, one footprint is newly added. To the state of time t in (A) of FIG. 12, footprint 93 is newly added at time t+1 in (B) of FIG. 12, and footprint 95 is further added at time t+2 in (C) of FIG. 12. The area of image 82 is determined by being scrolled by image scroll unit 41. That is, image scroll unit 41 scrolls the area of image 82 so as to cancel an area of the projection image moved by the person following control. By such a scroll, once projected footprint will be always projected at an identical position even if the position of the projection image is moved by the person following control.

With the aforementioned configuration, the image of a footprint is projected in the vicinity of the detected person. At this time, in the projection image, the image of a footprint is shifted in a direction opposite to the movement direction of driving unit 110 moved by the person following control (that is, the movement direction of the person). Thus, by shifting the image of a footprint in the opposite direction, the footprint seems to stand still when the image of a footprint is projected. That is, even if the position of the projection image is moved by the person following control, the footprint is always projected at an identical position, which allows natural display of the footprint.

In the present exemplary embodiment, for example, a texture image (or a background image) of a floor or wall may be used instead of the image of a footprint. By shifting the texture image of the floor or wall, in the direction opposite to the drive direction (that is, the movement direction of the person) in accordance with the movement speed of the driving unit, it is possible to show the texture image as if the texture image stands still on the projection surface.

### Another Exemplary Embodiment

As described above, the first to third exemplary embodiments have been described as illustration of the techniques to be disclosed in this application. However, the techniques in the present disclosure are not limited thereto, and may be applied to exemplary embodiments to which change, replacements, additions, and omissions have been made as necessary. In addition, it is also possible to make a new exemplary embodiment by combining elements described in the first to third exemplary embodiments. Therefore, another exemplary embodiment will be described below.

(1) Projector apparatus 100 according to the present disclosure is an example of the projection apparatus. Person position detector 11 according to the present disclosure is an example of the detector that detects the specific object. Video generator 400 and projection optical system 500 according to the present disclosure are an example of the projection unit. Driving unit 110 according to the present disclosure is an example of the driving unit that changes the direction of the projection unit. Controller 210 according to the present disclosure is an example of the controller that controls the driving unit.

(2) Although a person is detected as the specific object and control is performed for following movement of the person in the aforementioned exemplary embodiments, the specific object is not limited to a person. The specific object may be, for example, a moving object other than a person, such as an automobile and animal.

(3) Although distance information is used for detection of the specific object according to the aforementioned exemplary embodiments, the method for detecting the specific object is not limited thereto. Instead of distance detector 230, an imaging device capable of capturing an image formed by RGB light may be used. The specific object may be detected from the image captured by the imaging device, and furthermore, information such as the position, speed, direction, and distance of the specific object may also be detected.

(4) The techniques disclosed in the first to third exemplary embodiments may be combined as necessary.

As described above, the exemplary embodiments have been described as illustration of the techniques in the present disclosure. For this purpose, the accompanying drawings and detailed description have been provided.

Therefore, the components described in the accompanying drawings and detailed description may include not only essential components but also unessential components in order to illustrate the above-described techniques. Therefore, it should not be acknowledged immediately that those unessential components be essential because those unessential components are described in the accompanying drawings and detailed description.

In addition, since the aforementioned exemplary embodiments are intended to illustrate the techniques in the present disclosure, various changes, replacements, additions, omissions, etc. may be made within the scope of the appended claims or equivalents thereof.

The projection apparatus according to the present disclosure is applicable to various applications for projecting video on the projection surface.

What is claimed is:

1. A projection apparatus comprising:
a detector that detects a specific object;
a projection unit that projects a projection image indicated by a video signal;
a driving unit that changes a direction of the projection unit in order to change a projecting position of the projection image; and
a controller that controls the driving unit so that the projection image is projected at a position that follows movement of the specific object detected by the detector, the controller controlling processing of an image object included in the projection image in accordance with movement of the driving unit.

2. The projection apparatus according to claim 1, wherein
the image object included in the projection image is a spherical object, and
the controller changes a rotational speed of the spherical object in accordance with the movement of the driving unit.

3. The projection apparatus according to claim 1, wherein the controller applies blur processing according to the movement of the driving unit to the image object included in the projection image.

4. The projection apparatus according to claim 1, wherein the controller changes a speed of the movement, within an image, of the image object included in the projection image in accordance with the movement of the driving unit.

5. The projection apparatus according to claim 4, wherein the controller moves, in the projection image, the image object in a direction opposite to a direction corresponding to a direction of the movement of the driving unit.
